(19) United States
(12) Patent Application Publication
(10) Pub. No.: US 2025/0251705 A1
(43) Pub. Date: Aug. 7, 2025

(54) SYSTEMS AND METHODS OF POLICY GENERATION FOR NEW REWARD

(71) Applicant: Samsung Display Co., Ltd., Yongin-si (KR)

(72) Inventors: Shuhui Qu, Fremont, CA (US); Janghwan Lee, Pleasanton, CA (US); Kasra Yazdani, San Jose, CA (US)

(21) Appl. No.: 18/626,173

(22) Filed: Apr. 3, 2024

Related U.S. Application Data
(60) Provisional application No. 63/550,916, filed on Feb. 7, 2024.

(51) Int. Cl. G05B 13/02

(52) U.S. Cl. CPC G05B 13/0265

(57) ABSTRACT

A system includes: a processor; and memory storing instructions that, when executed by the processor, cause the processor to: receive a new reward function for a new evaluation criteria; generate a combined policy for the new reward function as a parameterized combination of a plurality of existing policies according to a performance threshold criteria; and generate a schedule based on the combined policy.

### CROSS-REFERENCE TO RELATED APPLICATION(S)

The present application claims priority to and the benefit of U.S. Provisional Application No. 63/550,916, filed on Feb. 7, 2024, entitled “POLICY COMBINATION: EFFICIENTLY POLICY GENERATION FOR NEW REWARD,” the entire content of which is incorporated by reference herein.

### BACKGROUND

### 1. Field

Aspects of embodiments of the present disclosure relate to systems and methods for policy generation using reinforcement learning.

### 2. Description of Related Art

Recently, manufacturing facilities have faced challenges in producing a diverse range of product lots, which can number in the hundreds of thousands, each undergoing numerous processes across multiple machines. Efficient coordination among these machines may be important to achieve higher productivity and increased utilization. However, human-based scheduling may necessitate extensive domain expertise and years of training in order to produce reasonable schedules. As such, machine learning-based scheduling methods and techniques, such as those based on Reinforcement Learning (RL), to automatically generate suitable schedules may be desired.

The above information disclosed in this Background section is for enhancement of understanding of the background of the present disclosure, and therefore, it may contain information that does not constitute prior art.

### SUMMARY

Generally, manufacturing facilities employ a set of evaluation criteria to assess the quality of a schedule by a given scheduling policy. For example, the quality may be determined by calculating the weighted sum of the evaluation criteria. However, these evaluation criteria may undergo frequent changes, which may encompass the set of criteria, the evaluation weights, and other related factors. For example, adjustments may be made to align with specific factory targets and requirements. Further, modifications of the evaluation criteria could occur both after project development and during deployment.

As such, the evolving evaluation criteria may not be pre-modeled during reinforcement learning training and optimization processes. Consequently, policies that are trained using previous reward functions may no longer be optimized for the updated evaluation criteria.

One or more embodiments of the present disclosure may be directed to systems and methods for generating a combined policy for a new reward function based on a combination of a plurality of existing policies that are trained based on existing reward functions.

According to one or more embodiments of the present disclosure a system includes: a processor; and memory storing instructions that, when executed by the processor, cause the processor to: receive a new reward function for a new evaluation criteria; generate a combined policy for the new reward function as a parameterized combination of a plurality of existing policies according to a performance threshold criteria; and generate a schedule based on the combined policy.

In an embodiment, the performance threshold criteria may include a first ratio compared with a second ratio.

In an embodiment, the first ratio may correspond to: a first difference between a new reward value obtained based on the new reward function and a first reward value obtained based on a first existing reward function of a first existing policy in the parameterized combination; and a second difference between the new reward value and a second reward value obtained based on a second existing reward function of a second existing policy in the parameterized combination.

In an embodiment, the second ratio may correspond to: a distance between the first existing policy and the combined policy; and a distance between the second existing policy and the combined policy.

In an embodiment, values of parameters for the existing policies in the parameterized combination for the combined policy may be selected based on a candidate combination having the first ratio closest to the second ratio.

In an embodiment, to generate the combined policy, the instructions may further cause the processor to: obtain an observation of a current state; generate a combination format for the parameterized combination; sample different candidate combinations of a set of parameters for the existing policies in the combination format over different parameter ranges; select parameter values for the generated combined policy from among the different candidate combinations that satisfy the performance threshold criteria; and select an action according to the generated combined policy with the selected parameter values.

In an embodiment, to select the parameter values for the generated combined policy, the instructions may further cause the processor to: obtain rewards for each of the different candidate combinations based on the new reward function, a first existing reward function of a first existing policy in the combination format, and a second existing reward function of a second existing policy in the combination format; calculate a first difference between a new reward obtained based on the new reward function and a first reward obtained based on the first existing reward function; calculate a second difference between the new reward and a second reward obtained based on the second existing reward function; and calculate a first ratio between the first difference and the second difference.

In an embodiment, to select the parameter values of the generated combined policy, the instructions may further cause the processor to: calculate a second ratio corresponding to a distance between the first existing policy and the combined policy and a distance between the second existing policy and the combined policy; compare the first ratio of each of the different candidate combinations with the second ratio; and select the parameter values for the generated combined policy from among the different candidate combinations having the first ratio that is closest to the second ratio.

According to one or more embodiments of the present disclosure, a method includes: receiving, by a processor, a new reward function for a new evaluation criteria; generating, by the processor, a combined policy for the new reward function as a parameterized combination of a plurality of existing policies according to a performance threshold criteria; and generating, by the processor, a schedule based on the combined policy.

In an embodiment, the performance threshold criteria may include a first ratio compared with a second ratio.

In an embodiment, the first ratio may correspond to: a first difference between a new reward value obtained based on the new reward function and a first reward value obtained based on a first existing reward function of a first existing policy in the parameterized combination; and a second difference between the new reward value and a second reward value obtained based on a second existing reward function of a second existing policy in the parameterized combination.

In an embodiment, the second ratio may correspond to: a distance between the first existing policy and the combined policy; and a distance between the second existing policy and the combined policy.

In an embodiment, values of parameters for the existing policies in the parameterized combination for the combined policy may be selected based on a candidate combination having the first ratio closest to the second ratio.

In an embodiment, the generating of the combined policy may include: obtaining, by the processor, an observation of a current state; generating, by the processor, a combination format for the parameterized combination; sampling, by the processor, different candidate combinations of a set of parameters for the existing policies in the combination format over different parameter ranges; selecting, by the processor, parameter values for the generated combined policy from among the different candidate combinations that satisfy the performance threshold criteria; and selecting, by the processor, an action according to the generated combined policy with the selected parameter values.

In an embodiment, the selecting of the parameter values for the generated combined policy may include: obtaining, by the processor, rewards for each of the different candidate combinations based on the new reward function, a first existing reward function of a first existing policy in the combination format, and a second existing reward function of a second existing policy in the combination format; calculating, by the processor, a first difference between a new reward obtained based on the new reward function and a first reward obtained based on the first existing reward function; calculating, by the processor, a second difference between the new reward and a second reward obtained based on the second existing reward function; and calculating, by the processor, a first ratio between the first difference and the second difference.

In an embodiment, the selecting of the parameter values of the generated combined policy may further include: calculating, by the processor, a second ratio corresponding to a distance between the first existing policy and the combined policy and a distance between the second existing policy and the combined policy; comparing, by the processor, the first ratio of each of the different candidate combinations with the second ratio; and selecting, by the processor, the parameter values for the generated combined policy from among the different candidate combinations having the first ratio that is closest to the second ratio.

According to one or more embodiments of the present disclosure, a system includes: a processor; and memory storing instructions that, when executed by the processor, cause the processor to: receive a new reward function for a new evaluation criteria; generate a combined policy for the new reward function as a parameterized combination of a plurality of existing policies according to a comparison between a first ratio and a second ratio; and generate a schedule based on the combined policy. The first ratio corresponds to: a first difference between a new reward value obtained based on the new reward function and a first reward value obtained based on a first existing reward function of a first existing policy in the parameterized combination; and a second difference between the new reward value and a second reward value obtained based on a second existing reward function of a second existing policy in the parameterized combination. The second ratio corresponds to a distance between the first existing policy and the combined policy and a distance between the second existing policy and the combined policy.

In an embodiment, to generate the combined policy, the instructions may further cause the processor to: obtain an observation of a current state; generate a combination format for the parameterized combination; sample different candidate combinations of a set of parameters for the existing policies in the combination format over different parameter ranges; select parameter values for the generated combined policy from among the different candidate combinations based on the comparison between the first ratio calculated for each of the different candidate combinations and the second ratio; and select an action according to the generated combined policy with the selected parameter values.

In an embodiment, to select the parameter values for the generated combined policy, the instructions may further cause the processor to: obtain rewards for each of the different candidate combinations based on the new reward function, a first existing reward function of a first existing policy in the combination format, and a second existing reward function of a second existing policy in the combination format; calculate a first difference between a new reward obtained based on the new reward function and a first reward obtained based on the first existing reward function; calculate a second difference between the new reward and a second reward obtained based on the second existing reward function; and calculate the first ratio between the first difference and the second difference for each of the different candidate combinations.

In an embodiment, to select the parameter values of the generated combined policy, the instructions may further cause the processor to: calculate the second ratio; compare the first ratio of each of the different candidate combinations with the second ratio; and select the parameter values for the generated combined policy from among the different candidate combinations having the first ratio that is closest to the second ratio.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a block diagram of a manufacturing facility according to one or more embodiments of the present disclosure;

FIG. 2 illustrates a reinforcement learning system in training according to one or more embodiments of the present disclosure;

FIG. 3 illustrates a scheduling system according to one or more embodiments of the present disclosure;

FIG. 4 is a flowchart of a method of generating a schedule from a combined policy according to one or more embodiments of the present disclosure;

FIG. 5 is a flowchart of a method of determining parameter values of the policies in a combined policy according to one or more embodiments of the present disclosure; and

FIG. 6 is a flowchart of a method of executing a schedule according to one or more embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

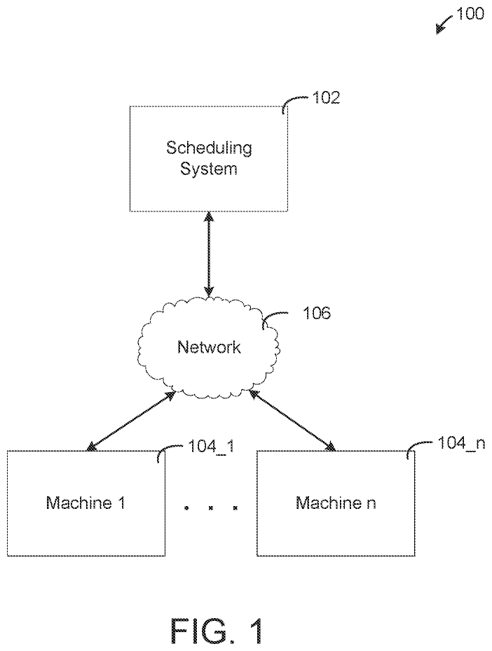

FIG. 1 is a block diagram of a manufacturing facility according to one or more embodiments of the present disclosure.

Referring to FIG. 1, the manufacturing facility 100 may be a factory for manufacturing various different products for various different customers (internal or external). As such, the manufacturing facility 100 may also be interchangeably referred to herein as a factory. The manufacturing facility 100 may include a scheduling system 102, and one or more machines 104_1 to 104_n connected to the scheduling system 102 over a network 106, where n is a natural number. The machines 104_1 to 104_n (which may be collectively referred to hereinafter as the machine 104 or the machines 104) may include (e.g., may be) various different manufacturing apparatuses that are used to manufacture various different products or product components.

The scheduling system 102 may include at least one compute resource (e.g., a processor), and memory containing instructions that, when executed by the compute resource (e.g., the processor), performs the operations described in more detail hereinafter. For example, the scheduling system 102 may automatically generate schedules to coordinate various processes for the machines 104 to manufacture a certain product or a certain product component.

As discussed in more detail below, according to one or more embodiments of the present disclosure, the scheduling system 102 may generate the schedules according to a reinforcement learning (RL) model that is trained and optimized based on a reward function corresponding to a goal, or in other words, an evaluation criteria of the manufacturing facility 100. The evaluation criteria of the manufacturing facility may correspond to an overall business goal of the manufacturing facility. For example, one evaluation criteria may be to produce the products or product components as quickly as possible to increase profits as much as possible. Another evaluation criteria may be to improve the quality of the products or product components, which may be a competing goal of the previously described evaluation criteria. One or more reward functions may be designed (e.g., by a domain expert) corresponding to each of the evaluation criteria, and the RL model may be trained based on the one or more reward functions to optimize a reward for a corresponding action.

The network 106 may include any suitable wired or wireless network (e.g., a Local Area Network (LAN), a Wide Area Network (WAN), cellular communications network, and/or the like). For example, the network 106 may include Frequency Division Multiple Access (FDMA), Time Division Multiple Access (TDMA), Code Division Multiple Access (CDMA) (e.g., Evolution-Data Optimized (EVDO)), Universal Mobile Telecommunications Systems (UMTS) (e.g., Time Division Synchronous CDMA (TD-SCDMA or TDS)), Wideband Code Division Multiple Access (WCDMA), Long Term Evolution (LTE), evolved Multimedia Broadcast Multicast Services (eMBMS), High-Speed Downlink Packet Access (HSDPA), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, Wi-Fi, any suitable wired network, combinations thereof, and/or the like.

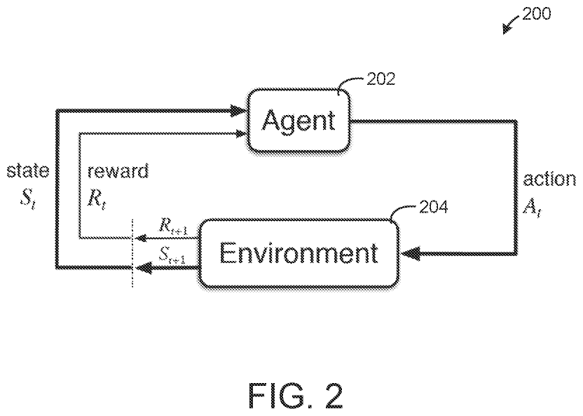

FIG. 2 illustrates a reinforcement learning system in training according to one or more embodiments of the present disclosure.

Referring to FIG. 2, a reinforcement learning system 200 may include an agent 202 and an environment 204. During training, as the agent 202 traverses the environment 204, it may generate or learn a set of rules or policies to help it decide which action to take next for an optimal reward. In other words, the policies generated by the agent 202 during training may be defined by a set of environment and agent states(S), a set of actions (A) taken by the agent 202, the probability of transition (P) from a current state(s) to a next state (s′) under an action (a), and an immediate reward (e.g., Rₐ(s, s′)) after transitioning from the current state(s) to the next state (s′) for taking the action (a).

In more detail, reinforcement learning (RL) is modeled as a Markov decision process (e.g., <S, A, R, P>). For example, at every time step (t), the agent 202 takes an action (Aₜ) in the environment 204 based on a current set of environment and agent states (Sₜ) and a reward (Rₜ) resulting from a previous action (e.g., Aₜ₋₁). A next set of environment and agent states (Sₜ₊₁) for a next time step (t+1) may be observed resulting from the action (Aₜ), and the resulting reward (e.g., Rₜ₊₁) for transitioning from the current state (Sₜ) to the next state (Sₜ₊₁) may be calculated. As a result of the training, a set of policies may be generated for the resulting RL model based on the reward functions, and during inference, the RL model may be deployed so that the policies may be used to automatically generate the schedules.

For example, when the RL model is optimized for a reward function corresponding to a goal or evaluation criteria of serving customers in the order in which they are received, the corresponding policy may be first-in first-out. As another example, when the RL model is optimized for a reward function corresponding to a goal or evaluation criteria of serving high priority customers first, the corresponding policy may be to serve a higher priority queue first or a shortest queue first.

However, it could take weeks or even months in order to effectively train and optimize the RL model from scratch to learn new policies for a given set of evaluation criteria. As such, if the evaluation criteria changes after development or even during deployment, the policies trained using previous reward functions corresponding to the previous evaluation criteria may no longer be optimized for the new or updated evaluation criteria. Moreover, during deployment, the factory may not have the time to wait weeks or even months typically needed to fully retrain the RL model based on the new or updated evaluation criteria, and industrial computers typically used by the factory to deploy the trained RL model may lack the computational resources (e.g., processing power) needed to fully retrain the RL model to be optimized for the new or updated evaluation criteria.

As will be discussed in more detail hereinafter, according to one or more embodiments of the present disclosure, a new combined policy may be generated as a parameterized (e.g., weighted) combination of the existing policies for a new reward function corresponding to the new or updated evaluation criteria. The parameters (e.g., weights) may be determined based on a performance threshold criteria. The performance threshold criteria may ensure that performance levels on the new or updated evaluation criteria of the combined policy exceeds those when using the existing policies alone.

While embodiments of the present disclosure are described in more detail hereinafter in the context of generating schedules for coordinating various manufacturing processes and the like for the machines 104, the present disclosure is not limited thereto. For example, the systems and methods described herein may be applicable to any suitable systems and methods that may benefit from generating a new combination of existing policies for a new reward function. In other words, as long as there is a policy that takes in some parameters/factors and outputs a decision/action, it can be combined with another policy according to one or more embodiments of the present disclosure. For example, the systems and methods described in more detail hereinafter may be applicable to various robotic control applications, navigation systems, autonomous driving applications, large language model training, and the like.

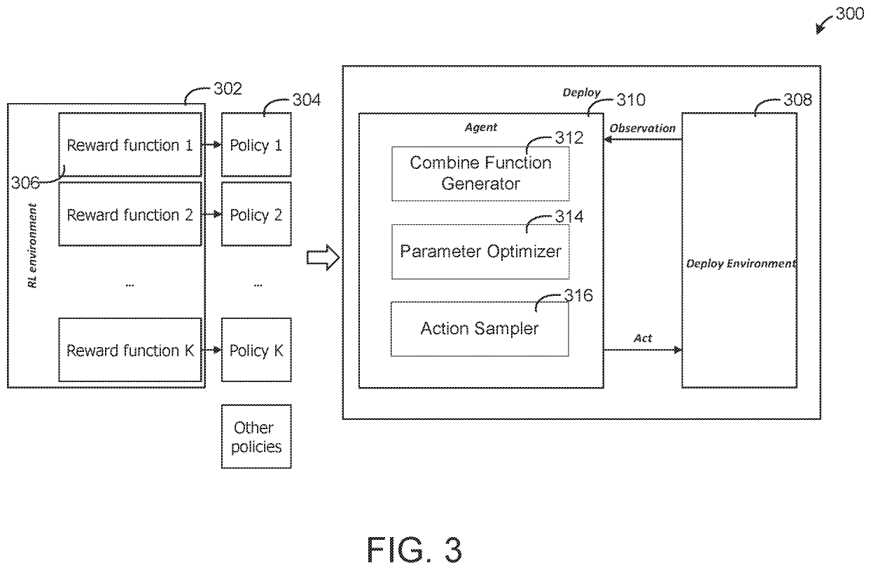

FIG. 3 illustrates a scheduling system according to one or more embodiments of the present disclosure. The scheduling system 300 shown in FIG. 3 may be the same or substantially the same as the scheduling system 102 described above with reference to FIG. 1, and thus, redundant description may not be repeated.

Referring to FIG. 3, according to one or more embodiments of the present disclosure, a new combined policy may be generated based on a new reward function corresponding to the new or updated evaluation criteria and according to a performance threshold criteria. The new combined policy may be generated as a parameterized (e.g., weighted) combination of the existing policies (e.g., which are trained based on the existing reward functions) based on the performance threshold criteria.

The performance threshold criteria may ensure that a performance gap between the performance of the combined policy for the new or updated evaluation criteria and the performance of an ideal or optimal policy for the new or updated evaluation criteria is minimized or reduced, such that a performance loss therebetween is guaranteed and controlled. In other words, performance levels for the new combined policy that are not significantly inferior to those of the optimal policy may be maintained, while adapting the scheduling system 300 to the new or updated evaluation criteria. The performance threshold criteria may precisely quantify the performance loss when transitioning from one evaluation criteria to another. The performance threshold criteria may unify the calculation of the performance loss under various possible evaluation criteria and performance metrics.

In more detail, as shown in FIG. 3, the scheduling system 300 may include an RL model that is previously trained (e.g., during development) in an RL environment 302 to generate the schedules based on one or more policies (which may be referred to hereinafter as existing policies) 304. Each of the existing policies 304 may be optimized for a specific reward function 306 (which may be referred to hereinafter as an existing reward function). The policies 304 optimized according to the reward functions 306 in the RL environment 302 may be deployed to a deployment environment 308, and used to generate the schedules for the machines 104 (e.g., see FIG. 1).

In some embodiments, after the pretrained RL model has been deployed, the scheduling system 300 may receive a new reward function corresponding to a new or updated evaluation criteria. For example, the new reward function may be provided from a domain expert and the like to correspond to the new or updated evaluation criteria. In this case, however, instead of retraining the RL model from scratch in the RL environment 302 to generate a new policy (e.g., the optimal policy) that is trained based on the new reward function, an agent 310 of the scheduling system 300 may generate a combined policy as a parameterized (e.g., a weighted) combination of the existing policies 304 based on the new reward function and the performance threshold criteria. In other words, the agent 310 may generate the new combined policy such that a performance gap or a performance loss as shown in Equation (1) below is smaller than a threshold for any new reward function without retraining the network (e.g., the neural network) from scratch.

$$\vert \sum {V}^{{π}^{*}} ( s ) - \sum {V}^{π} ( s ) \vert < η \qquad Equation ( l )$$

In Equation (1), V^{π*}(s) may represent a total optimal reward value for an optimal policy (π*) for that evaluation period, V^{π}(s) may represent a total reward value for the new combined policy (π) for that evaluation period, and n may represent the threshold (e.g., the performance gap threshold). The optimal policy (π*) may be defined (e.g., π*←<S, A, R_{new}, P>) based on the new reward function (R_{new}), and may correspond to a policy that would have been generated had the RL model been trained from scratch based on the new reward function. The new combined policy (π) may be defined as a combination of a set (K) of existing policies (πₖ) (e.g., π=ƒ(π_{k=1, . . . , K})). Each of the existing policies (πₖ) may be defined based on its corresponding existing reward function (Rₖ) (e.g., <S, A, Rₖ, P>⇒πₖ, k∈{1, . . . , K}). As such, V may be a value function, or in other words, the total accumulative reward over time. The optimal reward value (V^{π*}(s)) for the optimal policy (π*) may be provided from the domain expert and the like, or may be observed from the deployment environment 308 over time. Of course, the optimal reward value (V^{π*}(s)) may also be obtained by retraining the RL model from scratch based on the new reward function.

The new combined policy (π) may be generated as a parameterized (e.g., a weighted) combination of the existing policies (πₖ) for every time step (e.g., πₜ=ƒₜ(π_{i=1, . . . , K})), or for every period of time (e.g., π=ƒ(π_{i=1, . . . , K})). The format of a parameterized combination function (e.g., ƒₜ or ƒ) for the weighted combination may be a linear combination, a neural network, and the like (e.g., πₜ=Σαᵢπᵢ, πₜ=Ππᵢ^{α}^{ᵢ}, πₜ=e^{α}^{ᵢ}^{π}^{ᵢ}/Z(e^{α}^{ᵢ}^{π}^{ᵢ})), such that the parameters (e.g., αᵢ) of the combination may be determined through sampling and according to the performance threshold criteria. For example, the new combined policy (e.g., π or πₜ) may be selected by searching for values of the parameters (e.g., the αᵢ) in the combination that results in the performance threshold criteria being satisfied. Hereinafter, for convenience, the new combined policy may be described in more detail in the context of the combined policy (πₜ) generated for every time step (t) as a representative example, but the present disclosure is not limited thereto.

The performance threshold criteria may be used to ensure that the existing policies and their parameters in the new combined policy results in minimal or reduced performance loss based on Equation (1) above. For example, the performance threshold criteria may correspond to a comparison between a first ratio and a second ratio as shown in Equation (2) below for each candidate combination of parameters (e.g., weights) and policies in the combined policy.

$$\frac{{\sum }_{{t}_{p} = t}^{t + {t}_{k}} {γ}^{{t}_{p} - t} ( {R}_{new , {t}_{p} , i} - {R}_{i , {t}_{p}} )}{{\sum }_{{t}_{p} = t}^{t + {t}_{k}} {γ}^{{t}_{p} - t} ( {R}_{new , {t}_{p} , j} - {R}_{j , {t}_{p}} )} = \frac{{D}_{TV} ( {π}_{i} ( {s}_{t} ) ‖ π ( {s}_{t} ) )}{{D}_{TV} ( {π}_{j} ( {s}_{t} ) ‖ π ( {s}_{t} ) )} \qquad Equation ( 2 )$$

As shown in Equation (2), the first ratio may correspond to: 1) a difference between a new reward value obtained based on the new reward function (e.g., R_{new,t}_{ₚ}_{,i}) and a reward value obtained based on an existing reward function (e.g., R_{i,t}_{ₚ}) of a first existing policy (e.g., πᵢ(sₜ)) in the combination; over (e.g., divided by) 2) a difference between the new reward value obtained by the new reward function (e.g., R_{new,t}_{ₚ}_{,j}) and a reward value obtained based on an existing reward function (e.g., R_{j,t}_{ₚ}) for a second existing policy (e.g., πⱼ (sₜ)) in the combination. The second ratio may correspond to: 1) a distance (D_{TV}) of the first existing policy (e.g., πᵢ(sₜ)) to the combined policy (e.g., π(sₜ)); over (e.g., divided by) 2) a distance (D_{TV}) of the second existing policy (e.g., πᵢ(sₜ)) to the combined policy (e.g., π(sₜ)). In Equation (2), tₖ may correspond to the time step (t) for sampling, such that the larger the tₖ, the more accurate the sampling, but more compute resources needed for the sampling. Further, γ^{t}^{ₚ}^{-t} is the discounted factor for a reward along time. In more detail, γ is a discount factor, tp is a future time step, t is a current time. As a non-limiting example, if tₚ=0, t=0, Rₜ₊ₜ_{ₚ}=1, γ=0.95, then γ^{t}^{ₚ}^{-t}=1. This means that the current reward signal for the RL agent may not be discounted. On the other hand, if tₚ=1 as the future step, t=0, γ=0.95, then γ^{t}^{ₚ}^{-t}=0.95. This means that a future reward may be discounted by 0.95. The candidate combination having the first ratio that is approximately equal to the second ratio may be selected for the new combined policy of the time step (t).

As shown in Equation (3) below, by selecting the new combined policy that fulfills the performance threshold criteria described above with reference to Equation (2), the performance gap or performance loss of Equation (1) above may be guaranteed and controlled.

$$\vert \sum {V}^{{π}^{*}} ( s ) - \sum {V}^{π} ( s ) \vert \leq \frac{2 {R}_{n e w}^{max}}{1 - γ} {E}_{s ∼ {d}^{π}} [ {D}_{T V} ( {π}^{*} ( \cdot \vert s ) \vert π ( \cdot \vert s ) ) ] = η \qquad Equation ( 3 )$$

In other words, as shown in Equation (3) above, the second ratio of Equation (2) above may correspond to an expectation (E) of the steady state distribution (d^{π}) corresponding to a visitance to each state (s) under the corresponding policy (π) based on its distance D_{TV}, which is approximately equal to the threshold η. In Equation (3), R_{new}^{max} is the max reward in the system, and γ is a discount factor, such that

$$\frac{2 {R}_{n e w}^{max}}{1 - γ}$$

may define the value for the bound. As such, by ensuring that the performance threshold criteria shown in Equation (2) above is satisfied, the performance gap threshold of Equation (1) above may also be satisfied.

The agent 310 may be implemented as a processing circuit having a processor and memory. The processor may include a general-purpose processor, an Application Specific Integrated Circuit (ASIC), one or more Field Programmable Gate Arrays (FPGAs), a Digital Signal Processor (DSP), any other suitable electronic processing components, or combinations thereof. The memory may include tangible, non-transient, volatile memory, or non-volatile memory, for example, such as Random Access Memory (RAM), Read-Only Memory (ROM), Non-volatile RAM (NVRAM), Flash Memory, hard disk storage, any other suitable electronic storage medium, or combinations thereof. The memory stores instructions (e.g., data, computer code, and/or programming logic) that, when executed by the processor, performs the operations described herein. Accordingly, the memory includes database components, object code components, script components, and/or any other type of information structure for supporting the various activities and information structures described herein.

As shown in FIG. 3, in some embodiments, the agent 310 may include a combine function generator 312, a parameter (e.g., weight) optimizer 314, and an action sampler 316. Each of the combine function generator 312, the parameter optimizer 314, and the action sampler 316 may be implemented as instructions stored in the memory of the agent 310, or may be implemented as instructions distributed in one or more memories to be executed by one or more processors.

The combine function generator 312 may determine a parameterized combination format of the plurality of existing policies for the combined policy. As discussed above, the parameterized combination format may be a linear combination, a neural network, and the like (e.g., πₜ=Σαᵢπᵢ, πₜ=Ππᵢ^{α}^{ᵢ}, πₜ=e^{α}^{ᵢ}^{π}^{ᵢ}/Z(e^{α}^{ᵢ}^{π}^{ᵢ})) of the existing policies (e.g., πᵢ) and their corresponding parameters or weights (e.g., αᵢ) in the combination (e.g., the combined policy πₜ).

The parameter optimizer 314 may select the parameters (e.g., αᵢ) for the combination (πₜ) based on the performance threshold criteria discussed above with reference to Equation (2). For example, the parameter optimizer 314 may calculate the first ratio for each candidate combination, and may compare the first ratio with the second ratio. For example, in some embodiments, the parameter optimizer 314 may sort a list of the first ratios calculated for each of the candidate combinations, and select the candidate combination having the smallest first ratio, or the first ratio that is closest to the second ratio.

The action sampler 316 may sample (e.g., implement) the action corresponding to the combined policy into the deployment environment 308. As such, a schedule may be generated based on the action corresponding to the combined policy, and used to coordinate the machines 104 (e.g., see FIG. 1).

Hereinafter, a method of generating a schedule from a combined policy for a new reward function will be described in more detail.

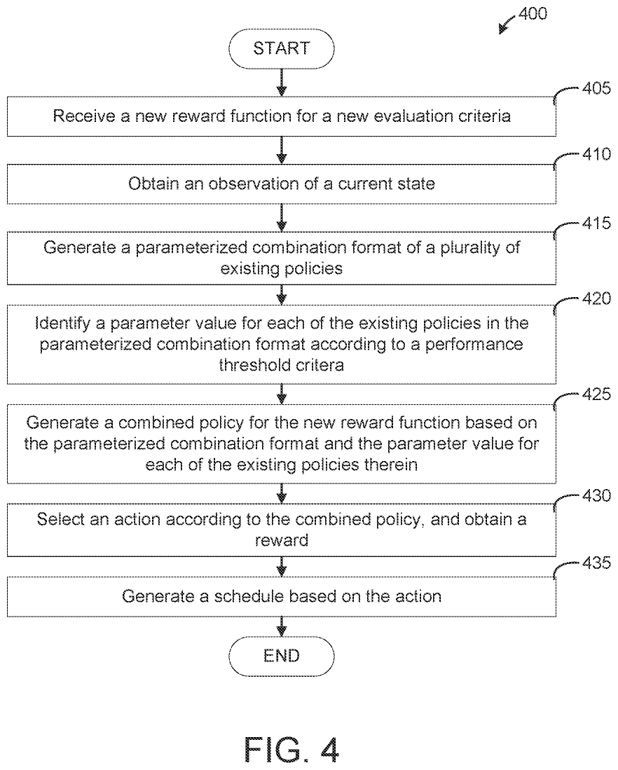

FIG. 4 is a flowchart of a method of generating a schedule from a combined policy according to one or more embodiments of the present disclosure.

The method 400 shown in FIG. 4, may be performed, for example, by the agent 310 (e.g., the combine function generator 312, the parameter optimizer 314, and the action sampler 316 thereof) described above with reference to FIG. 3. However, the present disclosure is not limited thereto, and the operations shown in the method 400 may be performed by any suitable one of the components and elements or any suitable combination of the components and elements of those of one or more example embodiments described above. Further, the present disclosure is not limited to the sequence or number of the operations of the method 400 shown in FIG. 4, and can be altered into any desired sequence or number of operations as recognized by a person having ordinary skill in the art. For example, in some embodiments, the order may vary, or the method 400 may include fewer or additional operations. Further, the operations shown in method 400 may be performed sequentially, or at least some of the operations thereof may be performed concurrently (e.g., simultaneously, or substantially simultaneously).

Referring to FIG. 4, the method 400 may start, and a new reward function (R_{new}) for a new evaluation criteria may be received at block 405. For example, the new reward function (R_{new}) may be provided from a domain expert, a plant manager, and the like, and may correspond to a new or updated evaluation criteria for assessing the quality of the schedules generated to coordinate the machines 104 (e.g., see FIG. 1). The new reward function (R_{new}) may be a weighted combination of the existing reward functions (Rₖ), a scale up of an existing reward function (Rₖ), or any other suitable type of reward function that is different from the existing reward functions (Rₖ).

An observation of a current state (sₜ) may be obtained at block 410, and a parameterized combination format (e.g., πₜ=ƒₜ(π_{i=1, . . . , K}, R_{i=1, . . . k})) of a plurality of existing policies may be generated at block 415. For example, in some embodiments, the agent 310 (e.g., the combine function generator 312) may determine a suitable combination function of a combination of a set (K) of existing policies (πₖ) (e.g., π=ƒ(π_{k=1, . . . , K})) for the new reward function. The combination may be generated for every time step (e.g., πₜ=ƒₜ(π_{i=1, . . . , K})), or for every period of time (e.g., π=ƒ(π_{i=1, . . . , K})). The format of the parameterized combination function (e.g., ƒₜ or ƒ) may be a linear combination, a neural network, and the like (e.g., πₜ=Σαᵢπᵢ, πₜ=Ππᵢ^{α}^{ᵢ}, πₜ=e^{α}^{ᵢ}^{π}^{ᵢ}/Z(e^{α}^{ᵢ}^{π}^{ᵢ})).

As a non-limiting example, the agent 310 (e.g., the combine function generator 312) may generate a combined function (πₜ) for each time step (t) based on the set (K) of existing policies and their corresponding reward functions (e.g., πₜ=ƒₜ(π_{i=1, . . . , K}, R_{i=1, . . . k})) in a linear combination format (e.g., πₜ=α₁π₁+α₂π₂+ . . . +αₙπₙ) of the existing policies (e.g., π₁, π₂, . . . πₙ) and their corresponding parameters or weights (e.g., α₁, α₂, . . . αₙ), but the present disclosure is not limited thereto.

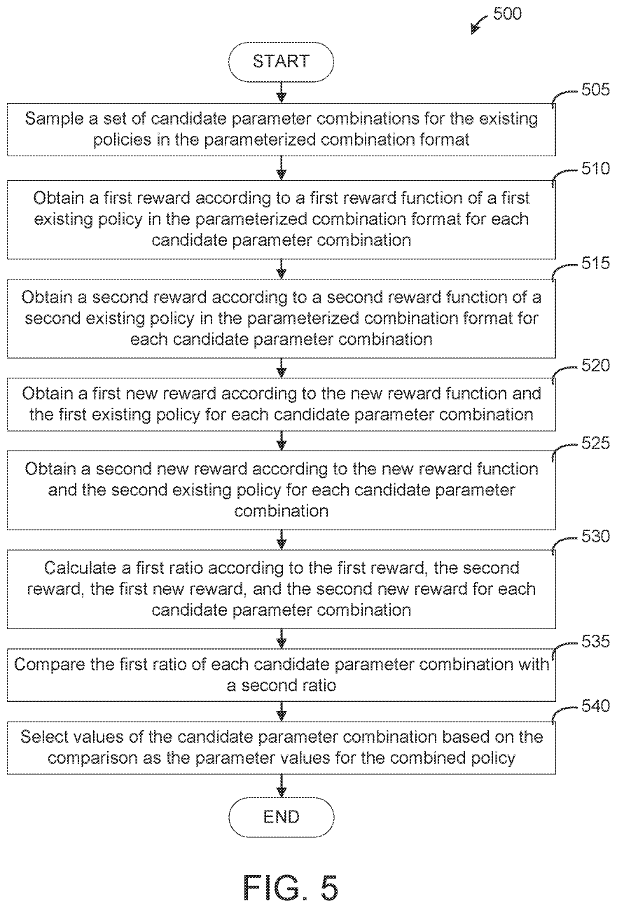

A parameter value (e.g., α₁, α₂, . . . αₙ) for each of the existing policies (e.g., π₁, π₂, . . . πₙ) in the parameterized combination format (e.g., πₜ=α₁π₁+α₂π₂+ . . . +αₙπₙ) may be identified according to a performance threshold criteria at block 420. The parameter values may be determined based on the new reward function and the existing reward function of each of the existing policies in the parameterized combination format. For example, in some embodiments, the parameter values may be determined based on the first ratio and the second ratio of the performance threshold criteria discussed above with reference to Equation (2). An example method in which the parameter values are calculated based on the performance threshold criteria for the parameterized combination format (e.g., πₜ=α₁τ₁+α₂π₂+ . . . +αₙπₙ) will be described in more detail below with reference to FIG. 5.

A combined policy for the new reward function may be generated at block 425 based on the parameterized combination format and the identified parameter value for each of the existing policies therein. For example, as discussed in more detail below with reference to FIG. 5, the agent 310 (e.g., the parameter optimizer 314) may select a candidate parameter combination from among a plurality of sampled candidate parameter combinations as the parameter values for the corresponding existing policies in the parameterized combination format of the generated combined policy. An action (e.g., αₜ=π(sₜ)) according to the combined policy may be selected (e.g., by the action sampler 316) for the current state (sₜ), and a corresponding reward (e.g., r_{new, t}) may be obtained at block 430. The schedule may then be generated based on the action at block 435, and the method 400 may end.

FIG. 5 is a flowchart of a method of determining parameter values of the policies in a combined policy according to one or more embodiments of the present disclosure. For example, in some embodiments, the method 500 shown in FIG. 5 may correspond to the block 420 of the method 400 described above with reference to FIG. 4.

The method 500 shown in FIG. 5, may be performed, for example, by the agent 310 (the parameter optimizer 314 and the action sampler 316 thereof) described above with reference to FIG. 3. However, the present disclosure is not limited thereto, and the operations shown in the method 500 may be performed by any suitable one of the components and elements or any suitable combination of the components and elements of those of one or more example embodiments described above. Further, the present disclosure is not limited to the sequence or number of the operations of the method 500 shown in FIG. 5, and can be altered into any desired sequence or number of operations as recognized by a person having ordinary skill in the art. For example, in some embodiments, the order may vary, or the method 500 may include fewer or additional operations. Further, the operations shown in method 500 may be performed sequentially, or at least some of the operations thereof may be performed concurrently (e.g., simultaneously, or substantially simultaneously).

Referring to FIG. 5, the method 500 may start (e.g., after the parameterized combination format of the plurality of existing policies is determined at block 415 of the method 400), and a set of candidate parameter combinations for the existing policies in the parameterized combination format may be sampled at block 505. For example, for the parameterized combination format (e.g., πₜ=α₁π₁+α₂π₂+ . . . +αₙπₙ) in the non-limiting example described above, a set of parameters ({α}) may be sampled in suitable corresponding ranges (e.g., α₁=range(0,1,0.01), α₂=range(1,0,−0.01), . . . , such that Σᵢα=1). In this case, the candidate parameter combination values (e.g., α₁π₁+α₂π₂+ . . . +αₙπₙ) may be obtained for each combination in the corresponding ranges.

For each candidate parameter combination (e.g., αᵢπᵢ+αⱼπⱼ), an existing reward based on its corresponding existing reward function may be obtained (e.g., rᵢ(sₜ,a_{π}_{ᵢ}), . . . , rᵢ(sₜ₊ₜ_{ₖ},a_{π}_{ᵢ})) and a new reward based on the new reward function may be obtained (e.g., r_{new}(sₜ,a_{π}_{ᵢ}), . . . , r_{new}(sₜ₊ₜ_{ₖ},a_{π}_{ᵢ})).

In other words, for each candidate parameter combination (e.g., πᵢ, πⱼ∈π_{k=1, . . . , K}), a first reward (e.g., R_{i,t}_{ₚ}) according to a first reward function of a first existing policy (πᵢ) in the parameterized combination format may be obtained at block 510, a second reward (e.g., R_{j,t}_{ₚ}) according to a second reward function of a second existing policy (πⱼ) in the parameterized combination format may be obtained at block 515, a first new reward (e.g., R_{new,t}_{ₚ}_{,i}) according to the new reward function and the first existing policy (πᵢ) may be obtained at block 520, and a second new reward (e.g., R_{new,t}_{ₚ}_{,j}) according to the new reward function and the second existing policy (πⱼ) may be obtained at block 525. For example, the first new reward (e.g., R_{new,t}_{ₚ}_{,i}) may be obtained by executing the first existing policy (πᵢ), and the second new reward (e.g., R_{new,t}_{ₚ}_{,j}) may be obtained by executing the second existing policy (πⱼ).

A first ratio (e.g., see left-hand side of Equation (2) above) according to the first reward, the second reward, the first new reward, and the second new reward for each candidate parameter combination (e.g., πᵢ, πⱼ∈π_{k=1, . . . , K}) may be calculated at block 530, and compared with a second ratio (e.g., see right-hand side of Equation (2) above) at block 535. In some embodiments, the comparison at block 535 may include sorting the first ratios of the candidate parameter combinations and selecting the smallest thereamong. In some embodiments, the comparison at block 535 may include sorting the first ratios according to differences from the second ratio therebetween, and selecting the smallest difference thereamong.

As such, based on the comparison (e.g., at block 535), the values of the candidate parameter combination that most closely satisfies the performance threshold criteria may be selected as the parameter values for the combined policy at block 540, and the method 500 may end, for example, such that the combined policy may be generated based on the selected values at block 425 of the method 400 described above with reference to FIG. 4.

Accordingly, the combined policy for the new reward function may be generated based on the parameterized combination format and the identified parameter value for each of the existing policies therein. An action (e.g., aₜ=π(sₜ)) according to the combined policy may be selected (e.g., by the action sampler 316) for the current state (sₜ), and a corresponding reward (e.g., r_{new, t}) may be obtained. The schedule may then be generated based on the action to coordinate the machines 104 (e.g., see FIG. 1) based on the schedule. As such, instead of retraining and optimizing the RL model from scratch for the new reward function, a parameterized (e.g., weighted) combination of the existing policies may be generated for the new reward function based on the performance threshold criteria, so that a performance gap between the schedules generated by the combined policy and the schedules generated by an ideal or optimized policy may be minimized or reduced.

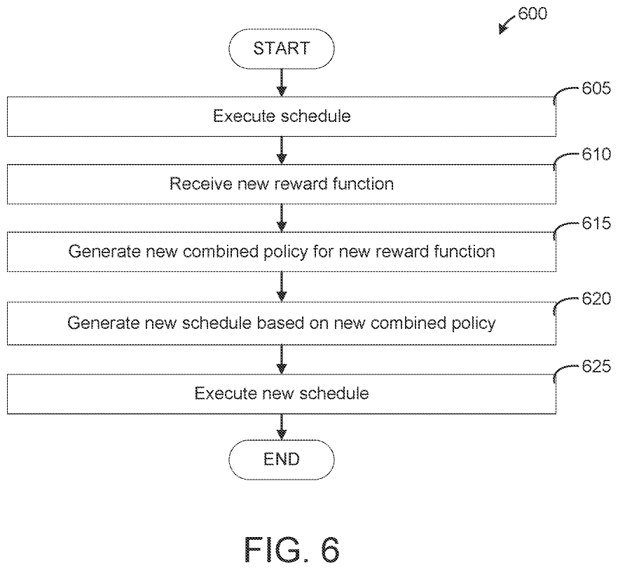

FIG. 6 is a flowchart of a method of executing a schedule according to one or more embodiments of the present disclosure.

The method 600 shown in FIG. 6, may be performed, for example, by the agent 310 (e.g., the combine function generator 312, the parameter optimizer 314, and the action sampler 316 thereof) described above with reference to FIG. 3. However, the present disclosure is not limited thereto, and the operations shown in the method 600 may be performed by any suitable one of the components and elements or any suitable combination of the components and elements of those of one or more example embodiments described above. Further, the present disclosure is not limited to the sequence or number of the operations of the method 600 shown in FIG. 6, and can be altered into any desired sequence or number of operations as recognized by a person having ordinary skill in the art. For example, in some embodiments, the order may vary, or the method 600 may include fewer or additional operations. Further, the operations shown in method 600 may be performed sequentially, or at least some of the operations thereof may be performed concurrently (e.g., simultaneously, or substantially simultaneously).

Referring to FIG. 6, the method 600 may start, and a schedule may be executed at block 605. For example, in some embodiments, the schedule may be executed to coordinate machine actions in a factory, schedule navigation tasks, coordinate language model tasks, and the like. A new reward function may be received at block 610. For example, in some embodiments, a new reward function corresponding to an evaluation criteria for the generated schedules may be received at block 610 (e.g., from a domain expert and the like).

A new combined policy may be generated for the new reward function at block 615. For example, the new combined policy may be generated for the new reward function as a parameterized (e.g., a weighted) combination of a plurality of existing policies based on the new reward function and the performance threshold criteria as discussed above with reference to the methods 400 and 500 of FIGS. 4 and 5. As a result, a new schedule may be generated based on the new combined policy at block 620.

The new schedule may be executed at block 625, and the method 600 may end. For example, executing the new schedule at block 625 may include changing the order of machine operations, selecting different navigation tasks, changing an order of language model tasks, and the like, based on the new schedule.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A system comprising:
a processor; and
memory storing instructions that, when executed by the processor, cause the processor to:
receive a new reward function for a new evaluation criteria;
generate a combined policy for the new reward function as a parameterized combination of a plurality of existing policies according to a performance threshold criteria; and
generate a schedule based on the combined policy.

2. The system of claim 1, wherein the performance threshold criteria comprises a first ratio compared with a second ratio.

3. The system of claim 2, wherein the first ratio corresponds to:
a first difference between a new reward value obtained based on the new reward function and a first reward value obtained based on a first existing reward function of a first existing policy in the parameterized combination; and
a second difference between the new reward value and a second reward value obtained based on a second existing reward function of a second existing policy in the parameterized combination.

4. The system of claim 3, wherein the second ratio corresponds to:
a distance between the first existing policy and the combined policy; and
a distance between the second existing policy and the combined policy.

5. The system of claim 2, wherein values of parameters for the existing policies in the parameterized combination for the combined policy is selected based on a candidate combination having the first ratio closest to the second ratio.

6. The system of claim 1, wherein to generate the combined policy, the instructions further cause the processor to:
obtain an observation of a current state;
generate a combination format for the parameterized combination;
sample different candidate combinations of a set of parameters for the existing policies in the combination format over different parameter ranges;
select parameter values for the generated combined policy from among the different candidate combinations that satisfy the performance threshold criteria; and
select an action according to the generated combined policy with the selected parameter values.

7. The system of claim 6, wherein to select the parameter values for the generated combined policy, the instructions further cause the processor to:
obtain rewards for each of the different candidate combinations based on the new reward function, a first existing reward function of a first existing policy in the combination format, and a second existing reward function of a second existing policy in the combination format;
calculate a first difference between a new reward obtained based on the new reward function and a first reward obtained based on the first existing reward function;
calculate a second difference between the new reward and a second reward obtained based on the second existing reward function; and
calculate a first ratio between the first difference and the second difference.

8. The system of claim 7, wherein to select the parameter values of the generated combined policy, the instructions further cause the processor to:
calculate a second ratio corresponding to a distance between the first existing policy and the combined policy and a distance between the second existing policy and the combined policy;
compare the first ratio of each of the different candidate combinations with the second ratio; and
select the parameter values for the generated combined policy from among the different candidate combinations having the first ratio that is closest to the second ratio.

9. A method comprising:
receiving, by a processor, a new reward function for a new evaluation criteria;
generating, by the processor, a combined policy for the new reward function as a parameterized combination of a plurality of existing policies according to a performance threshold criteria; and
generating, by the processor, a schedule based on the combined policy.

10. The method of claim 9, wherein the performance threshold criteria comprises a first ratio compared with a second ratio.

11. The method of claim 10, wherein the first ratio corresponds to:
a first difference between a new reward value obtained based on the new reward function and a first reward value obtained based on a first existing reward function of a first existing policy in the parameterized combination; and
a second difference between the new reward value and a second reward value obtained based on a second existing reward function of a second existing policy in the parameterized combination.

12. The method of claim 11, wherein the second ratio corresponds to:
a distance between the first existing policy and the combined policy; and
a distance between the second existing policy and the combined policy.

13. The method of claim 10, wherein values of parameters for the existing policies in the parameterized combination for the combined policy is selected based on a candidate combination having the first ratio closest to the second ratio.

14. The method of claim 9, wherein the generating of the combined policy comprises:
obtaining, by the processor, an observation of a current state;
generating, by the processor, a combination format for the parameterized combination;
sampling, by the processor, different candidate combinations of a set of parameters for the existing policies in the combination format over different parameter ranges;
selecting, by the processor, parameter values for the generated combined policy from among the different candidate combinations that satisfy the performance threshold criteria; and
selecting, by the processor, an action according to the generated combined policy with the selected parameter values.

15. The method of claim 14, wherein the selecting of the parameter values for the generated combined policy comprises:
obtaining, by the processor, rewards for each of the different candidate combinations based on the new reward function, a first existing reward function of a first existing policy in the combination format, and a second existing reward function of a second existing policy in the combination format;
calculating, by the processor, a first difference between a new reward obtained based on the new reward function and a first reward obtained based on the first existing reward function;
calculating, by the processor, a second difference between the new reward and a second reward obtained based on the second existing reward function; and
calculating, by the processor, a first ratio between the first difference and the second difference.

16. The method of claim 15, wherein the selecting of the parameter values of the generated combined policy further comprises:
calculating, by the processor, a second ratio corresponding to a distance between the first existing policy and the combined policy and a distance between the second existing policy and the combined policy;
comparing, by the processor, the first ratio of each of the different candidate combinations with the second ratio; and
selecting, by the processor, the parameter values for the generated combined policy from among the different candidate combinations having the first ratio that is closest to the second ratio.

17. A system comprising:
a processor; and
memory storing instructions that, when executed by the processor, cause the processor to:
receive a new reward function for a new evaluation criteria;
generate a combined policy for the new reward function as a parameterized combination of a plurality of existing policies according to a comparison between a first ratio and a second ratio; and
generate a schedule based on the combined policy,
wherein the first ratio corresponds to:
a first difference between a new reward value obtained based on the new reward function and a first reward value obtained based on a first existing reward function of a first existing policy in the parameterized combination; and
a second difference between the new reward value and a second reward value obtained based on a second existing reward function of a second existing policy in the parameterized combination, and
wherein the second ratio corresponds to a distance between the first existing policy and the combined policy and a distance between the second existing policy and the combined policy.

18. The system of claim 17, wherein to generate the combined policy, the instructions further cause the processor to:
obtain an observation of a current state;
generate a combination format for the parameterized combination;
sample different candidate combinations of a set of parameters for the existing policies in the combination format over different parameter ranges;
select parameter values for the generated combined policy from among the different candidate combinations based on the comparison between the first ratio calculated for each of the different candidate combinations and the second ratio; and
select an action according to the generated combined policy with the selected parameter values.

19. The system of claim 18, wherein to select the parameter values for the generated combined policy, the instructions further cause the processor to:
obtain rewards for each of the different candidate combinations based on the new reward function, a first existing reward function of a first existing policy in the combination format, and a second existing reward function of a second existing policy in the combination format;
calculate a first difference between a new reward obtained based on the new reward function and a first reward obtained based on the first existing reward function;
calculate a second difference between the new reward and a second reward obtained based on the second existing reward function; and
calculate the first ratio between the first difference and the second difference for each of the different candidate combinations.

20. The system of claim 19, wherein to select the parameter values of the generated combined policy, the instructions further cause the processor to:
calculate the second ratio;
compare the first ratio of each of the different candidate combinations with the second ratio; and
select the parameter values for the generated combined policy from among the different candidate combinations having the first ratio that is closest to the second ratio.
